(19) United States
(12) Patent Application Publication
(10) Pub. No.: US 2004/0160948 A1
(43) Pub. Date: Aug. 19, 2004

(54) IP network communication apparatus

(75) Inventor: Toshihisa Ozu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/635,578

(22) Filed: Aug. 7, 2003

(30) Foreign Application Priority Data
Feb. 19, 2003 (JP) 2003-041436

(51) Int. Cl. H04L 12/66; H04M 9/08

(52) U.S. Cl. 370/352; 379/406.01

(57) ABSTRACT

An IP network communication apparatus within a local station transmits a control packet including the time of transmission of the control packet to an opposing station by way of an IP network. When receiving the control packet sent back thereto from the opposing station by way of the IP network, the IP network communication apparatus calculates a transmission path delay that IP packets undergo during one round trip between the local station and the opposing station from the time of the receipt of the control packet and the transmission time. As a result, even if there is a difference between a transmission path from the sending side to the receiving side and a transmission path from the receiving side to the sending side, the IP network communication apparatus can determine the transmission path delay with a high degree of accuracy.

### BACKGROUND OF THE INVENTION

1. Field of the Invention

The present invention relates to an IP network communication apparatus that interfaces between a public switched telephone network (PSTN) and an Internet Protocol (IP) network.

2. Description of Related Art

When two IP network communication apparatuses are placed opposite to each other with an IP network being located between them, a voice sent from an end terminal within a local station side is transmitted, by way of the two IP network communication apparatuses, to another end terminal within an opposing station. An echo can occur in a 4-wire to 2-wire conversion hybrid located on a far side of the opposing station and is sent to the end terminal within the local station.

Conventionally, such an echo can be canceled by setting up an echo canceller in the IP network communication apparatus located within the opposing station. However, because the echo canceller is not always set up in the IP network communication apparatus located in the opposing station, it is therefore necessary for the local station to make an adjustment together with the opposing station.

Japanese patent application publication No. 2001-333000 discloses a technology for canceling an echo that occurs in a 4-wire to 2-wire conversion hybrid located on a far side of an opposing station by setting up an echo canceller in an IP network communication apparatus located within a local station (refer to paragraphs having numbers [0008] to [0025] and FIG. 1). Thus the local station side can independently remove echoes without making an adjustment together with the opposing station by using the IP network communication apparatus disclosed in Japanese patent application publication No. 2001-333000. When removing the echo on the local station side, the IP network communication apparatus disclosed by the above-mentioned patent application publication calculates a transmission path delay that IP packets being transmitted from the local station to the opposing station undergoes from the transmission time based on a clock located on the local station and the reception time based on a clock located on the opposing station. The IP network communication apparatus then multiplies the transmission path delay by two so as to calculate a transmission path delay that IP packets undergo during one round trip between the sending and receiving sides.

A problem encountered with a prior art IP network communication apparatus constructed as mentioned above is that while the prior art IP network communication apparatus can remove echoes with a high degree of accuracy on the local station side if the transmission path delay that IP packets undergo during one round trip between the sending and receiving sides is accurate, if there is a time lag between a clock on the local station side and anther clock on the opposing station side, the prior art IP network communication apparatus cannot accurately determine the transmission path delay that IP packets undergo during one round trip between the sending and receiving sides and therefore cannot remove echoes with a high degree of accuracy on the local station side. Another problem is that because the prior art IP network communication apparatus calculates the transmission path delay which IP packets undergo for one round trip by multiplying the transmission path delay that they have undergone for one way by two, the prior art IP network communication apparatus cannot accurately determine the transmission path delay that IP packets undergo during one round trip between the sending and receiving sides and therefore cannot remove echoes with a high degree of accuracy on the local station side when there is a difference between the transmission path via which IP packets are transmitted from the sending side to the receiving side and the transmission path via which IP packets are transmitted from the receiving side to the sending side.

### SUMMARY OF THE INVENTION

The present invention is proposed to solve the above-mentioned problems, and it is therefore an object of the present invention to provide an IP network communication apparatus that can improve the accuracy of calculation of a transmission path delay that IP packets undergo during one round trip between a local station side and an opposing station side so as to enable the local station side to surely remove echoes.

In accordance with the present invention, there is provided an IP network communication apparatus that transmits a control packet including the time of the transmission of the control packet to an opposing station by way of an IP network and, when receiving the control packet sent back thereto by way of the IP network, calculates a transmission path delay that IP packets undergo during one round trip between the sending and receiving sides from the time of the reception of the control packet and the transmission time contained in the control packet. Therefore, even if there is a difference between the transmission path via which IP packets are transmitted from the sending side to the receiving side and the transmission path via which IP packets are transmitted from the receiving side to the sending side, the IP network communication apparatus can determine the transmission path delay that IP packets undergo during one round trip between the sending and receiving sides with a high degree of accuracy, thereby making it possible for the sending side to surely remove an echo from a digital signal to be sent out onto a public switched telephone network.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a transmission system to which an IP network communication apparatus according to embodiment 1 of the present invention is applied; and

FIG. 2 is a block diagram showing the structure of the IP network communication apparatus according to embodiment 1 of the present invention.

### DETAILED DESCRIPTION OF THE PREFERRED EMBODIMENTS

The invention will now be described with reference to the accompanying drawings.

Embodiment 1.

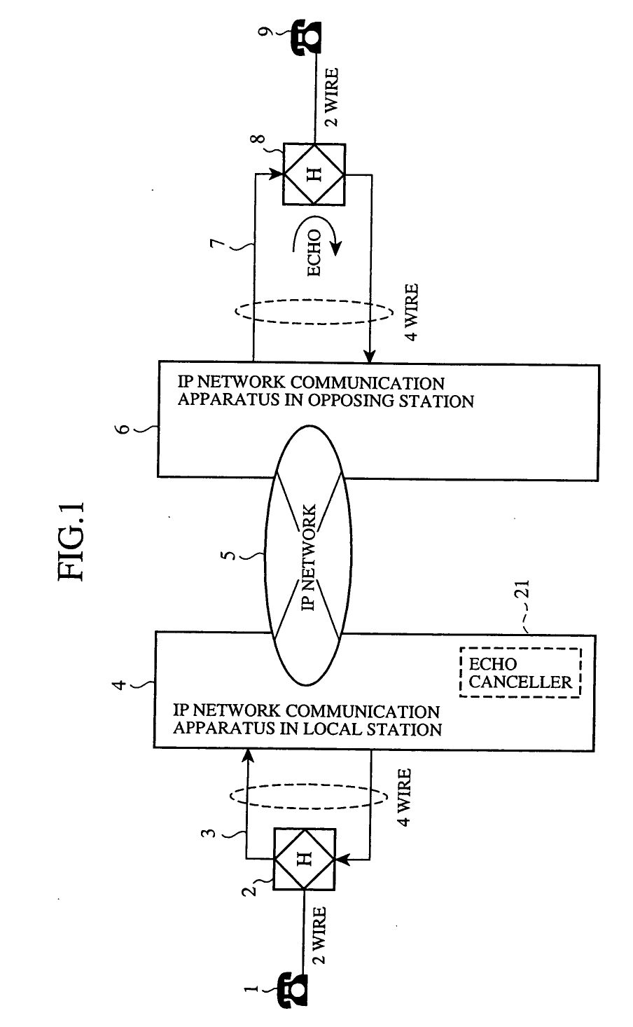

FIG. 1 is a block diagram showing the structure of a transmission system to which an IP network communication apparatus in accordance with embodiment 1 of the present invention is applied. In the figure, a local end terminal 1 corresponds to a telephone or facsimile apparatus, for example. For example, the end terminal 1 sends out a sound signal caused by a voice generated by a user or a signal generated by a facsimile apparatus as a digital signal. A local hybrid 2 is connected via 2 wires with the end terminal 1 and is also connected via 4 wires with a PSTN 3. For example, the local hybrid 2 converts a 2-wire signal that is a digital signal sent from the end terminal 1 into a 4-wire signal.

When receiving the 4-wire signal that is the digital signal by way of the PSTN 3 from the hybrid 2, the IP network communication apparatus 4 on the local station side converts the digital signal into IP packets so as to generate frames, and sends out a corresponding frame signal onto the IP network 5. On the other hand, when receiving a frame signal from the IP network 5, the IP network communication apparatus 4 on the local station side retrieves IP packets from the frame signal, converts the IP packets back into a digital signal, and sends out the digital signal onto the PSTN 3. The IP network communication apparatus 4 incorporates an echo canceller 21.

When receiving a frame signal from the IP network 5, an IP network communication apparatus 6 on the opposing station side retrieves IP packets from the frame signal, converts the IP packets back into a digital signal, and sends out the digital signal onto a PSTN 7. On the other hand, when receiving a 4-wire signal that is a digital signal by way of the PSTN 7, the IP network communication apparatus 6 converts the digital signal into IP packets so as to generate frames, and sends out a corresponding frame signal onto the IP network 5. The IP network communication apparatus 6 on the opposing station side can incorporate an echo canceller. As an alternative, the IP network communication apparatus 6 may incorporate no echo canceller. In accordance with this embodiment 1, it is assumed that the IP network communication apparatus 6 incorporates no echo canceller.

In the opposing station, a hybrid 8 is connected via 2 wires with an end terminal 9, and is connected via 2 wires with the PSTN 7. For example, the hybrid 8 converts a 4-wire signal, which is a digital signal delivered from the PSTN 7, into a 2-wire signal. The end terminal 9 within the opposing station can be a telephone or facsimile apparatus, for example. For example, the end terminal 9 receives a 2-wire signal that is a digital signal delivered from the hybrid 8.

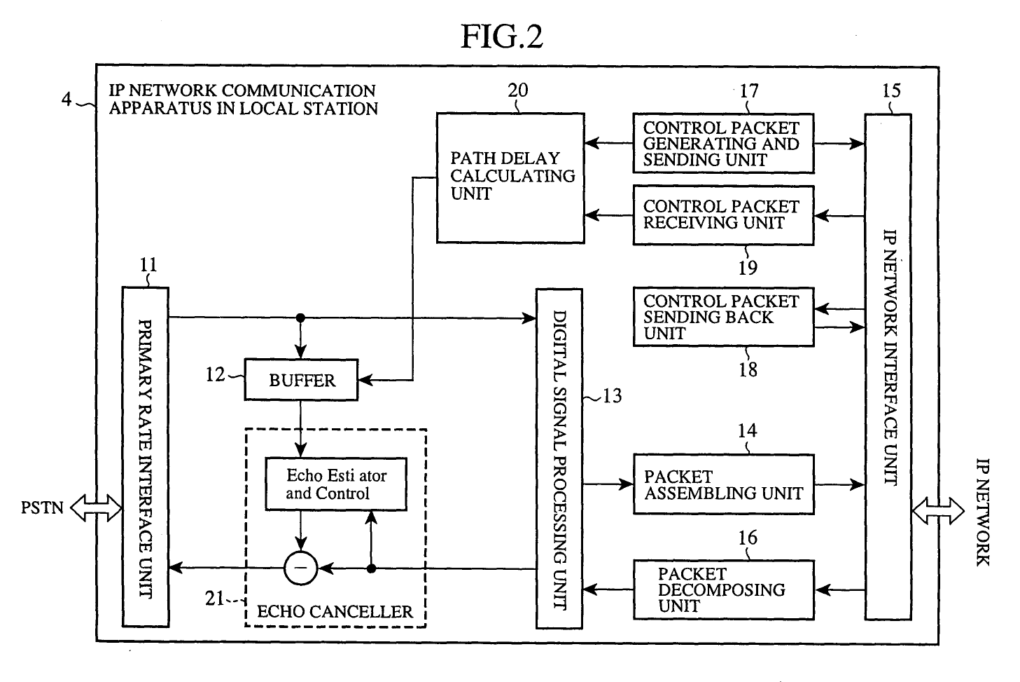

FIG. 2 is a block diagram showing the structure of the IP network communication apparatus 4 in accordance with embodiment 1 of the present invention. In the figure, a primary rate interface unit 11 terminates a 4-wire signal (i.e., a primary group signal) from the PSTN 3 and extracts a PCM (Pulse Code Modulation) signal from the primary group signal. The primary rate interface unit 11 generates a primary group signal from a PCM signal delivered from the echo canceller 21 and sends out the primary group signal onto the PSTN 3. A buffer 12 constitutes a digital signal storage means for temporarily storing the PCM signal extracted by the primary rate interface unit 11.

A digital signal processing unit 13 performs predetermined digital signal processing (for example, an encoding process, a level calculation process of calculating the level of a background noise, and a background noise insertion process). A packet assembling unit 14 assembles IP packets by applying RTP (Real-time Transport Protocol) or UDP (User Datagram Protocol) to a digital signal digital-signal-processed by the digital signal processing unit 13, for example.

While an IP network interface unit 15 converts the IP packets assembled by the packet assembling unit 14 into Ethernet (registered trademark) frames, and sends out a corresponding frame signal onto the IP network 5, the IP network interface unit 15 decomposes a frame signal sent from the IP network 5 into IP packets and then delivers the IP packets to a depacketizing unit 16. The depacketizing unit 16 performs RTP decomposing or UDP decomposing on each of the IP packets delivered from the IP network interface unit 15, for example.

A transmitting means can be comprised of the primary rate interface unit 11, the digital signal processing unit 13, the packet assembling unit 14, and the IP network interface unit 15, and a receiving means can be comprised of the primary rate interface unit 11, the digital signal processing unit 13, the IP network interface unit 15, and the depacketizing unit 16.

A control packet generating and transmitting unit 17 generates a control packet used for calculation of a transmission path delay that IP packets undergo during one round trip between the local station and the opposing station, and delivers the control packet to the IP network interface unit 15. When generating the control packet, the control packet generating and transmitting unit 17 introduces time stamp information indicating the time of the transmission of the control packet into the control packet. When receiving the control packet used for the calculation of the transmission path delay from the IP network communication apparatus 6 within the opposing station, a control packet sending back unit 18 sends the control packet back to the IP network communication apparatus 6 within the opposing station. A control packet sending back unit 18 is installed in the IP network communication apparatus 6 within the opposing station. The control packet sending back unit 18 of the IP network communication apparatus 6 within the opposing station sends the control packet transmitted from the control packet generating and transmitting unit 17 back to the IP network communication apparatus 4 within the local station.

A control packet receiving unit 19 receives the control packet sent back thereto by the control packet sending back unit 18 of the IP network communication apparatus 6 within the opposing station. A path delay calculating unit 20 calculates the transmission path delay that IP packets undergo during one round trip between the sending and receiving sides from the time of the reception of the control packet by the control packet receiving unit 19 and the transmission time represented by the time stamp information contained in the control packet. A delay calculating means can be comprised of the control packet generating and transmitting unit 17, the control packet sending back unit 18, the control packet receiving unit 19, and the path delay calculating unit 20.

The echo canceller 21 removes a far side echo superimposed on a received PCM signal, which is delivered from the digital signal processing unit 13, by using a PCM signal that is selected from among PCM signals stored in the buffer 12 and that was stored the transmission path delay ahead of time, the transmission path delay being calculated by the path delay calculating unit 20. The echo canceller 21 constitutes an echo removing means.

Next, a description will be made as to an operation of the transmission system. First of all, when the end terminal 1 within the local station sends out a sound signal as a digital signal, for example, the hybrid 2 within the local station converts the 2-wire signal that is the digital signal sent from the end terminal 1 into a 4-wire signal. When receiving the 4-wire signal that is a digital signal by way of the PSTN 3 from the hybrid 2, the IP network communication apparatus 4 within the local station converts the digital signal into IP packets so as to generate frames, and sends out a corresponding frame signal onto the IP network 5.

Concretely, the primary rate interface unit 11 of the IP network communication apparatus 4 terminates the 4-wire signal (i.e., a primary group signal) from the PSTN 3 and extracts a PCM signal from the primary group signal so as to store the PCM signal in the buffer 12, and then delivers the PCM signal to the digital signal processing unit 13. When receiving the PCM signal from the primary rate interface unit 11, the digital signal processing unit 13 performs predetermined digital signal processing on the PCM signal and delivers the digital-signal-processed digital signal to the packet assembling unit 14.

When receiving the digital-signal-processed digital signal from the digital signal processing unit 13, the packet assembling unit 14 assembles IP packets by applying RTP or UDP to the digital signal, for example. The IP network interface unit 15 converts the IP packets assembled by the packet assembling unit 14 into Ethernet (registered trademark) frames, and sends out a corresponding frame signal onto the IP network 5.

When the IP network communication apparatus 4 within the local station thus sends out a frame signal onto the IP network 5, as previously mentioned, the IP network communication apparatus 6 within the opposing station receives the frame signal from the IP network 5, retrieves IP packets from the frame signal, and converts the IP packets back into a PCM signal so as to generate a 4-wire signal. The detailed description of the processing will be omitted hereafter. When receiving the 4-wire signal that is a digital signal from the IP network communication apparatus 6, the hybrid 8 within the opposing station converts the 4-wire signal into a 2-wire signal and delivers the 2-wire signal to the end terminal 9 within the opposing station. When the hybrid 8 within the opposing station converts the 4-wire signal into a 2-wire signal, an echo might occur. The echo is thus superimposed on a sound signal sent from the end terminal 9 within the opposing station, i.e., a 4-wire signal delivered from the hybrid 8 to the IP network communication apparatus 6. When receiving the 4-wire signal that is a digital signal from the hybrid 8, the IP network communication apparatus 6 within the opposing station converts the digital signal into IP packets so as to generate frames, and sends out a corresponding frame signal onto the IP network 5.

When receiving a frame signal from the IP network 5, the IP network communication apparatus 4 within the local station retrieves IP packets from the frame signal, converts the IP packets back into a digital signal, and sends out the digital signal onto the PSTN 3. Concretely, the IP network interface unit 15 of the IP network communication apparatus 4 decomposes the frame signal sent from the IP network 5 so as to retrieve the IP packets, and delivers the IP packets to the depacketizing unit 16. When receiving the IP packets from the IP network interface unit 15, the depacketizing unit 16 of the IP network communication apparatus 4 performs RTP decomposing or UDP decomposing on each of the IP packets, for example, and delivers a digital signal to the digital signal processing unit 13. When receiving the digital signal from the depacketizing unit 16, the digital signal processing unit 13 of the IP network communication apparatus 4 performs predetermined digital signal processing on the digital signal and delivers the received PCM signal to the echo canceller 21.

The control packet generating and transmitting unit 17 of the IP network communication apparatus 4 generates a control packet used for the calculation of the transmission path delay and delivers the control packet to the IP network interface unit 15 in order for the echo canceller 21 to remove an echo component included in the received PCM signal with a high degree of accuracy. When generating the control packet, the control packet generating and transmitting unit 17 introduces time stamp information indicating the time of the transmission of the control packet into the control packet. When receiving the control packet including the time stamp information from the control packet generating and transmitting unit 17, the IP network interface unit 15 converts the control packet into an Ethernet (registered trademark) frame and sends out a corresponding frame signal onto the IP network 5.

When receiving the frame signal from the IP network 5, the IP network interface unit 15 installed in the IP network communication apparatus 6 within the opposing station decomposes the frame signal so as to retrieve the control packet, and delivers the control packet to the control packet sending back unit 18. When receiving the control packet from the IP network interface unit 15, the control packet sending back unit 18 installed in the IP network communication apparatus 6 within the opposing station delivers the control packet to the IP network interface unit 15 at once. When receiving the control packet from the control packet sending back unit 18, the IP network interface unit 15 installed in the IP network communication apparatus 6 within the opposing station converts the control packet into an Ethernet (registered trademark) frame and sends out a corresponding frame signal onto the IP network 5.

When receiving the frame signal from the IP network 5, the IP network interface unit 15 of the IP network communication apparatus 4 decomposes the frame signal so as to retrieve the control packet, and delivers the control packet to the control packet receiving unit 19. When receiving the control packet from the IP network interface unit 15, the control packet receiving unit 19 of the IP network communication apparatus 4 delivers the control packet to the path delay calculating unit 20. When the control packet receiving unit 19 receives the control packet, the path delay calculating unit 20 of the IP network communication apparatus 4 calculates the transmission path delay that IP packets undergo during one round trip between the sending and receiving sides from the time of the reception of the control packet by the control packet receiving unit 19 and the transmission time represented by the time stamp information contained in the control packet. The path delay calculating unit 20 then transmits an instruction to output a PCM signal that was stored the transmission path delay time earlier to the buffer 12.

When receiving the PCM signal from the buffer 12, and also receiving the received PCM signal from the digital signal processing unit 13, the echo canceller 21 of the IP network communication apparatus 4 compares the PCM signal with the received PCM signal so as to identify an echo component, and then removes the echo component from the received PCM signal. When receiving the received PCM signal from the echo canceller 21, the primary rate interface unit 11 of the IP network communication apparatus 4 generates a primary group signal from the received PCM signal and sends out the primary group signal onto the PSTN 3. When receiving the 4-wire signal that is the primary group signal from the IP network communication apparatus 4, the hybrid 2 within the local station converts the 4-wire signal into a 2-wire signal and then delivers the 2-wire signal to the end terminal 1 within the local station.

As can be seen from the above description, in accordance with this embodiment 1, the IP network communication apparatus transmits a control packet including the time of the transmission of the control packet to the opposing station by way of the IP network 5 and, when receiving the control packet sent back thereto by way of the IP network 5, calculates a transmission path delay that IP packets undergo during one round trip between the sending and receiving sides from the time of the reception of the control packet and the transmission time contained in the control packet. Therefore, even if there is a difference between the transmission path via which IP packets are transmitted from the sending side to the receiving side and the transmission path via which IP packets are transmitted from the receiving side to the sending side, the IP network communication apparatus can determine the transmission path delay that IP packets undergo during one round trip between the sending and receiving sides with a high degree of accuracy, thereby making it possible for the local station side to surely remove an echo from a digital signal to be sent out onto a public switched telephone network.

Embodiment 2.

In accordance with embodiment 2, the IP network communication apparatus 4 within the local station can calculate a transmission path delay time that IP packets undergo during one round trip between the sending and receiving sides by generating and sending a control packet to the IP network interface unit 15 at predetermined intervals using the control packet generation transmission unit 17.

As a result, the IP network communication apparatus 4 can dynamically calculate the transmission path delay that IP packets undergo during one round trip between the sending and receiving sides even if the transmission path delay changes because of a change in the transmission path in the IP network 5.

Embodiment 3.

In accordance with embodiment 3, instead of calculating a transmission path delay time that IP packets undergo during one round trip between the sending and receiving sides by generating and sending a control packet to the IP network interface unit 15 at predetermined intervals using the control packet generation transmission unit 17, the IP network communication apparatus 4 within the local station can generate and deliver a control packet to the IP network interface unit 15 by using the control packet generation transmission unit 17 when receiving a calculation instruction from a host computer (not shown) that handles the transmission path in the IP network 5.

As a result, the IP network communication apparatus 4 can calculate the transmission path delay that IP packets undergo during one round trip between the sending and receiving sides if necessary without performing useless calculation of the transmission path delay.

Many widely different embodiments of the present invention may be constructed without departing from the spirit and scope of the present invention. It should be understood that the present invention is not limited to the specific embodiments described in the specification, except as defined in the appended claims.

What is claimed is:

1. An IP network communication apparatus including a transmitting means for converting a digital signal delivered from a public switched telephone network into IP packets, and for transmitting the IP packets to an opposing station by way of an IP network, and a receiving means for, when receiving IP packets from said opposing station by way of said IP network, converting the IP packets back to a digital signal and sending out it onto said public switched telephone network, said IP network communication apparatus comprising:
a digital signal storage means for storing digital signals transmitted to said IP network communication apparatus from said public switched telephone network therein;
a delay calculating means for transmitting a control packet including time of transmission of the control packet to said opposing station by way of said IP network, and for, when receiving the control packet sent back thereto from said opposing station by way of said IP network, calculating a transmission path delay that IP packets undergo during one round trip between said IP network communication apparatus and said opposing location from time of the receipt of the control packet and the transmission time contained in the control packet; and
an echo removing means for removing a far side echo superimposed on the digital signal, which is sent out onto said public switched telephone network by said receiving means, by using a digital signal that is selected from among digital signals stored in said digital signal storage means and that was stored the transmission path delay time earlier.

2. The IP network communication apparatus according to claim 1, wherein said delay calculating means calculates the transmission path delay at predetermined intervals.

3. The IP network communication apparatus according to claim 1, wherein said delay calculating means calculates the transmission path delay when receiving an instruction for the calculation of the transmission path delay.

4. The IP network communication apparatus according to claim 1, wherein the digital signal which is converted into IP packets by said transmitting means is a sound signal, and the digital signal which said receiving means sends out onto said public switched telephone network is a sound signal.
